(19) United States
(12) Patent Application Publication
(10) Pub. No.: US 2017/0334511 A1
(43) Pub. Date: Nov. 23, 2017

(54) ADJUSTABLE BICYCLE SHOE CLEAT

(71) Applicant: VP COMPONENTS CO., LTD., TAICHUNG CITY (TW)

(72) Inventor: WEN-HWA LIN, TAICHUNG CITY (TW)

(21) Appl. No.: 15/159,704

(22) Filed: May 19, 2016

(51) Int. Cl. B62M 3/08

(52) U.S. Cl. CPC B62M 3/086

(57) ABSTRACT

An adjustable bicycle shoe cleat is provided which is fixed to a bottom plate of a bicycle shoe, wherein the bottom plate is provided with two combining holes. The adjustable bicycle shoe cleat includes a cleat body and a fastening assembly. The cleat body has a front engaging end and an opposite rear engaging end. Two adjusting bores are symmetrically and transversely disposed between the front engaging end and the rear engaging end. Each adjusting bore has a small arch section and a large arch section. The two small arch sections are disposed face to face. The fastening assembly passes through the two adjusting bores by two screw members for loosenably screwing the cleat body to the two combining holes, such that the cleat body is able to be biasedly positioned against the bottom plate, facilitating the adjustment of the shoe cleat against the bicycle shoe.

### BACKGROUND OF THE INVENTION

### 1. Field of the Invention

The present invention relates to bicycle shoe cleats, and more particularly, to an adjustable bicycle shoe cleat.

### 2. Description of the Related Art

A bicycle shoe cleat is usually fixed on the bottom of the bicycle shoe for being engaged with a clipless pedal of the bicycle, such that the user stably cast the pedaling force on the pedal, thereby increasing the pedal rising and lowering efficiency.

However, a conventional bicycle shoe cleat is only able to be longitudinally or transversely adjusted, failing to meet the user's demand. Different users may have different pedaling angles due to possible foot arch pronation, foot arch supination, knee injury or knee surgery, so as to affect the pedaling efficacy. If the shoe cleat is unable to be adjusted to achieve a suitable engaging angle, the user is only capable of engaging the shoe cleat and the clipless pedal at a fixed angle. As a result, the user is prevented from smoothly and efficiently disengaging the shoe cleat from the clipless pedal, causing time wasting or even a dangerous situation. Furthermore, the angles of the left foot and right foot of the user against the left and right clipless pedals may not be identical. Therefore, choosing a suitable and applicable shoe cleat is relatively important for a bicycle rider.

### SUMMARY OF THE INVENTION

For improving aforementioned issues, embodiments of the present invention disclose an adjustable bicycle shoe cleat. When being at a disengagement status, with the adjusting bore of the cleat body providing a bias space or rotation allowance, the cleat body is able to bias at an angle against the bottom of the bicycle shoe. The bicycle rider is allowed to adjust the cleat to a position with a suitable angle, thereby smoothly and efficiently engaging or disengaging the shoe cleat from the clipless pedal.

For achieving the objectives above, embodiments of the present invention provide an adjustable bicycle shoe cleat which is fixed to a bottom plate of a bicycle shoe, wherein the bottom plate of the bicycle shoe is provided with two combining holes. The adjustable bicycle shoe cleat comprises:
a cleat body provided with a front engaging end and a rear engaging end in opposite with the front engaging end for being engaged with a clipless pedal, two adjusting bores symmetrically and transversely disposed between the front engaging end and the rear engaging end, each adjusting bore comprising a small arch section and a large arch section, the two small arch sections disposed face to face; and
a fastening assembly provided with two screw members passing through the two adjusting bores for loosenably screwing the cleat body to the two combining holes, such that the cleat body is able to be biasedly positioned against the bottom plate of the bicycle shoe. With such configuration, the shoe cleat is disposed in a position defining an adjustable angle with the bottom plate of the bicycle shoe.

In embodiments of the present invention, the combining holes are strip-shaped and longitudinally disposed in parallel on the bottom plate of the bicycle shoe.

In embodiments of the present invention, the bottom plate of the bicycle shoe is provided with an inner face and an outer face. The fastening assembly further includes a first fixing member disposed on the inner face and a second fixing member disposed on the outer face. The second fixing member and the cleat body are passed through by the screw members and thereby screwed to the first fixing member.

In embodiments of the present invention, the cleat body is provided with a first surface and a second surface. The first surface faces the combining holes. The adjusting bores are concavely disposed from the first surface toward the second surface. The second surface is concavely provided with a containing recess having a square measure larger than the square measure of the second fixing member, wherein the containing recess contains the second fixing member.

In embodiments of the present invention, the first fixing member is provided with two pillars passing through the combining holes. Further, each pillar has a screw hole for the screw member to be screwed thereto.

In embodiments of the present invention, the second fixing member is provided with two counterbores for containing the head part of the screw member, thereby preventing the head part of the screw member from protruding from the second surface of the cleat body.

In embodiments of the present invention, two sides of the containing recess are provided with a blocking edge, respectively.

In embodiments of the present invention, the blocking edges are V-shaped.

In embodiments of the present invention, each screw member is provided with a tool driving bore.

In embodiments of the present invention, the inner face of the bottom plate of the bicycle shoe is provided with a recess, such that the combining holes are disposed in the recess.

With such configuration, the present invention allows the user/bicycle rider to adjust the angle define by the shoe cleat and the bottom plate of the bicycle shoe in advance, whereby the shoe cleat is smoothly and efficiently engaged with or disengaged from the clipless pedal. The time needed for the disengagement is shortened and the smoothness of the pedal being pedaled to rise and lower is increased.

### BRIEF DESCRIPTION OF THE DRAWINGS

FIG. 1 is an exploded view of the adjustable bicycle shoe cleat and the bottom plate of the bicycle shoe in accordance with embodiments of the present invention.

FIG. 2 is an exploded view displaying the content of FIG. 1 from another point of view.

FIG. 3 is a front view of the second surface of the cleat body in accordance with embodiments of the present invention.

FIG. 4 is a sectional schematic view illustrating an embodiment of the present invention installed on the bottom plate of the bicycle shoe.

FIG. 5 is a bottom view of an embodiment of the present invention installed on the bottom plate of the bicycle shoe.

FIG. 6 is another bottom view of an embodiment of the present invention installed on the bottom plate of the bicycle shoe, illustrating the cleat body being biasedly adjusted against the bottom plate of the bicycle shoe.

FIG. 7 is another bottom view of an embodiment of the present invention installed on the bottom plate of the bicycle shoe, illustrating the cleat body being longitudinally adjusted against the bottom plate of the bicycle shoe.

FIG. 8 is another bottom view of an embodiment of the present invention installed on the bottom plate of the bicycle shoe, illustrating the cleat body being transversely adjusted against the bottom plate of the bicycle shoe.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

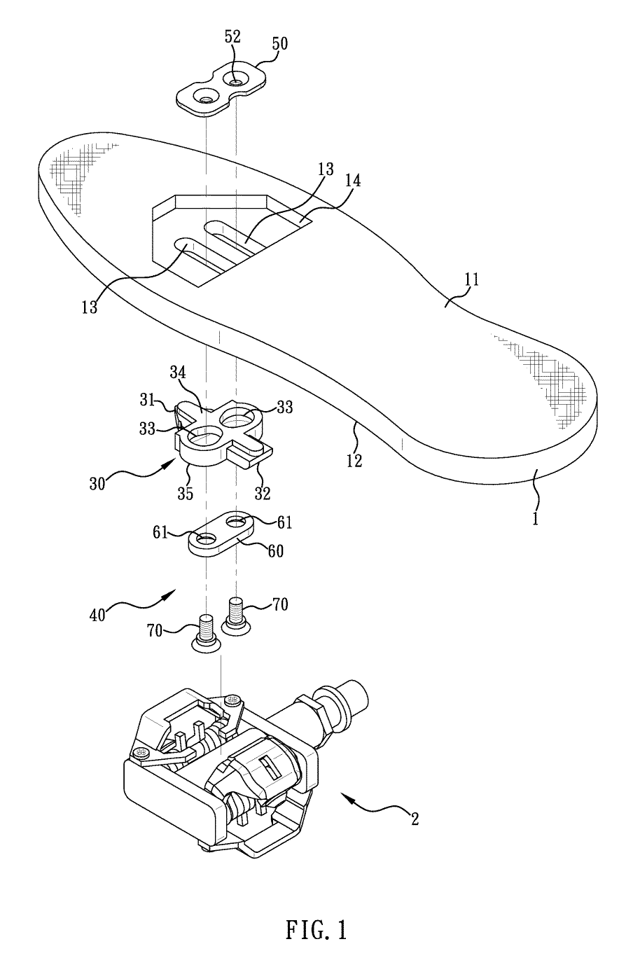

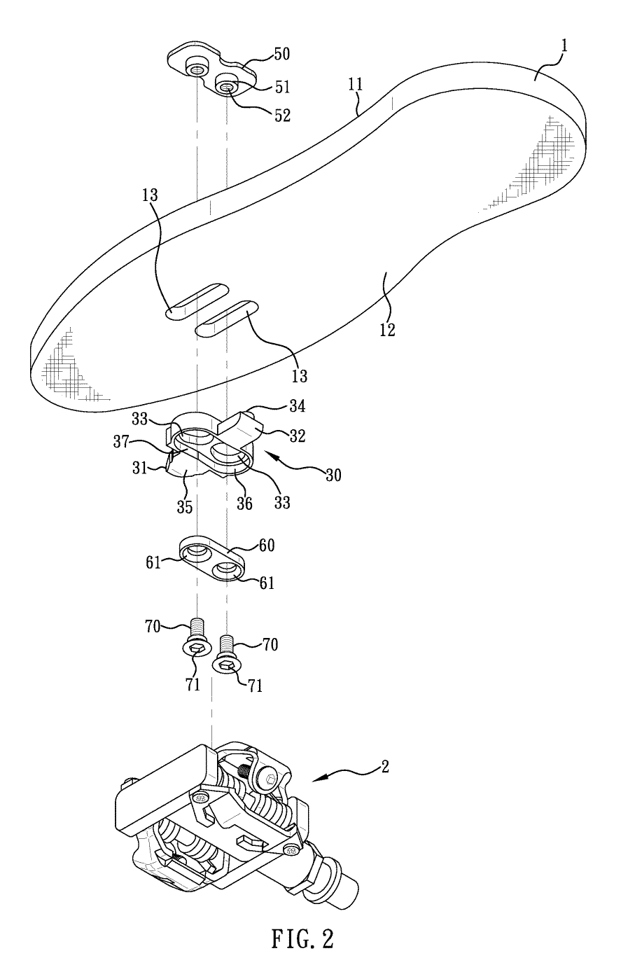

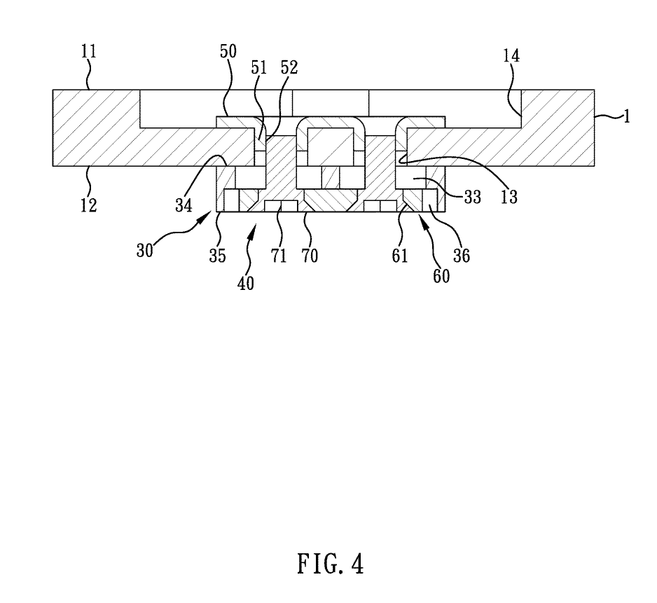

Referring to FIG. 1 to FIG. 6, the embodiments of the present invention provide an adjustable bicycle shoe cleat, which is fixed on a bottom plate 1 of a bicycle shoe for being combined to a clipless pedal 2. The adjustable bicycle shoe cleat comprises a cleat body 30 and a fastening assembly 40. The bottom plate 1 is provided with an inner face 11, an outer face 12, and two combining holes 13, wherein the combining holes 13 are strip-shaped and longitudinally disposed in parallel on the bottom plate 1. Further, the inner face 11 has a recess 14, with the two combining holes 13 disposed therein.

The cleat body 30 is provided with a front engaging end 31 and a rear engaging end 32 disposed in opposite to the front engaging end 31. When the cleat body 30 is mounted on the bottom plate 1 of the bicycle shoe by use of the fastening assembly 40, the front engaging end 31 points to the toes of the user/bicycle rider, while the rear engaging end 32 points to the heel of the user/bicycle rider. The front engaging end 31 and the rear engaging end 32 are engaged with the clipless pedal 2.

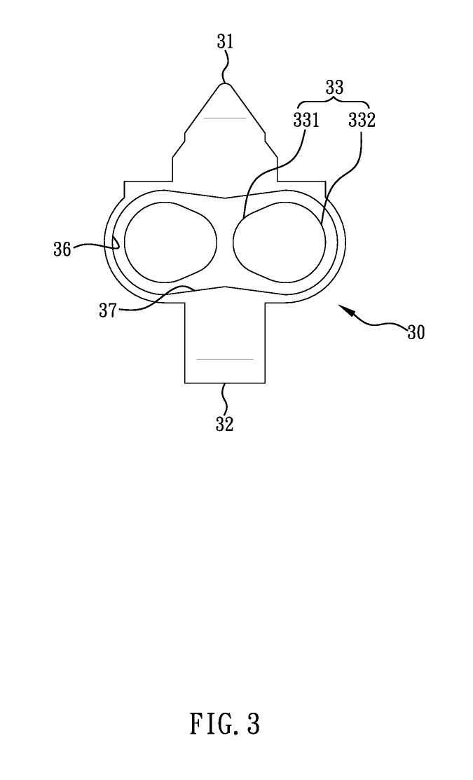

Referring to FIG. 3, two adjusting bores 33 are symmetrically and transversely disposed between the front engaging end 31 and the rear engaging end 32. The adjusting bores 33 are not circularly shaped. Each adjusting bore 33 comprises a small arch section 331 and a large arch section 332, wherein the two small arch sections 331 are disposed face to face adjacent the center of the cleat body 30. The large arch sections 332 are disposed adjacent to the outer periphery of the cleat body 30.

The cleat body 30 further comprises a first surface 34 and a second surface 35. The first surface 34 faces the combining holes 13. The two adjusting bores 33 are concavely disposed from the first surface 34 toward the second surface 35. The second surface 35 is concavely provided with a containing recess 36, wherein two sides of the containing recess 36 are provided with a blocking edge 37, respectively. In the preferred embodiments, the blocking edges 37 are V-shaped.

The fastening assembly 40 is provided with a first fixing member 50, a second fixing member 60, and two screw members 70. The first fixing member 50 is disposed on the inner face 11 of the bottom plate 1 of the bicycle shoe, preferably in the recess 14. Also, the first fixing member 50 has two pillars 51 passing through the two combining holes 13, wherein the two pillars 51 have a screw hole 52, respectively. The second fixing member 60 is disposed on the outer face 12 and contained in the containing recess 36 of the cleat body 30. In the preferred embodiment, the containing recess 36 has a square measure larger than the square measure of the second fixing member 60. The second fixing member 60 has two counterbores 61 for containing the head part of the two screw members 70, whereby the head part of the two screw members 70 are prevented from protruding from the second surface 35 of the cleat body 30. Furthermore, each screw member 70 is provided with a hexagonal tool driving bore 71 for being driven by a hexagonal wrench.

When the cleat body 30 is screwed to the bottom plate 1 of the bicycle shoe by the fastening assembly 40, each of the two screw members 70 passes through the respective counterbore 61 on the second fixing member 60, the adjusting bore 33 of the cleat body 30, and the respective combining hole 13 to be screwed to the respective screw hole 52 on the first fixing member 50, whereby the cleat body 30 is loosenably mounted on the two combining holes 13.

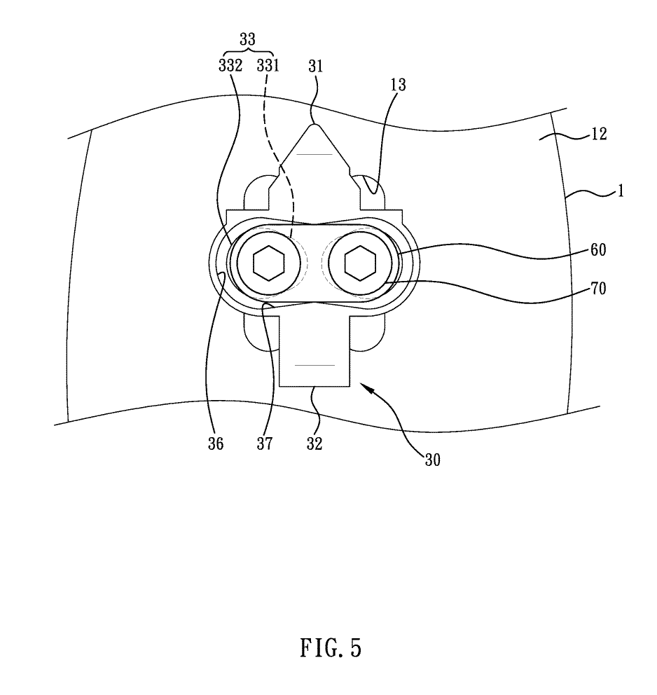

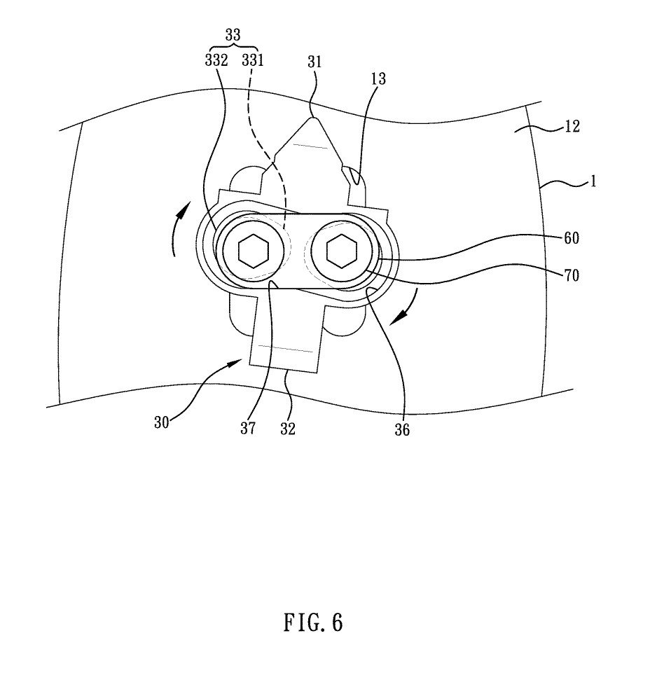

Referring to FIG. 5 and FIG. 6, when the two screw members 70 are loosened, with the large arch section 332 of the adjusting bores 33, the cleat body 30 is provided with a biasing space or rotating allowance, such that the cleat body 30 is able to be biasedly positioned to define a bias angle with the bottom plate 1 of the bicycle shoe. By adjusting the angle defined by the cleat body 30 and the bottom plate 1, the respective pointing direction of the front engaging end 31 and the rear engaging end 32 are adjusted. As a result, the user/bicycle rider is allowed to adjust a suitable angle included by the cleat body 30 and the bottom plate 1 in advance, so as to smoothly and efficiently engage or disengage the cleat body 30 and the clipless pedal 2. The time needed for disengagement is shortened, and the smoothness of user pedaling is facilitated. Especially, when the cleat body 30 is adjusted to reach the maximum adjusting limitation, the blocking edge 37 contacts and stop the second fixing member 60 as a stopping boundary.

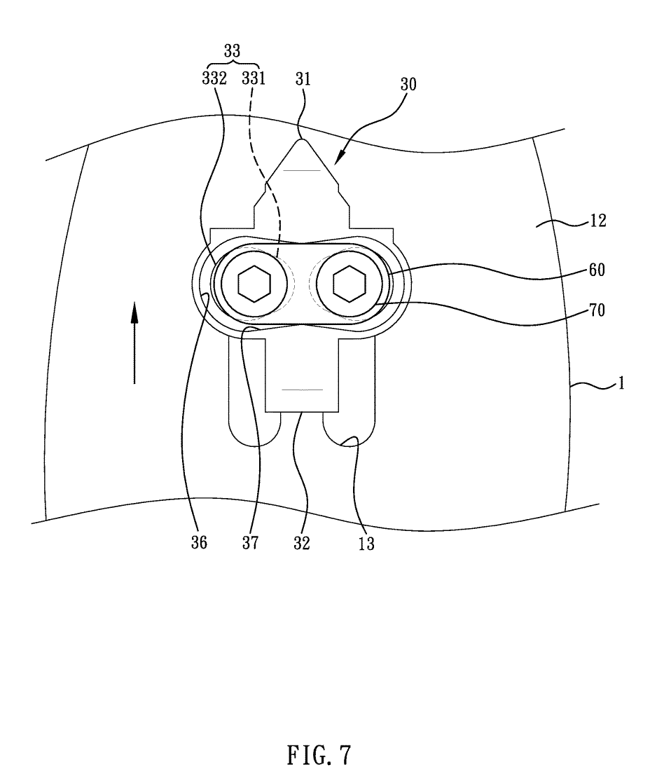

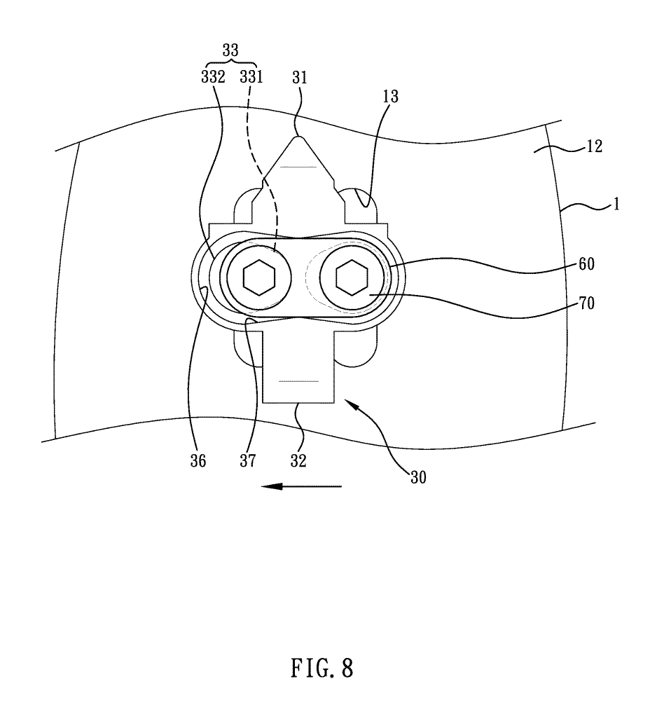

In addition, referring to FIG. 7 and FIG. 8, the longitudinal or transverse adjustment is made possible in the embodiments provided by the present invention. When the two screw members 70 are loosened, the cleat body 30 is able to be longitudinal adjusted along the combining holes 13. Also, due to the adjusting bores 33 being not circularly shaped, the cleat body 30 is able to be transversely adjusted along the disposal direction of the adjusting bores 33 according to the pedaling tendency suitable for different users/bicycle riders.

With such configuration, a biasing space or rotating allowance is provided by the large arch sections 332 and the small arch sections 331 of the adjusting bores 33. When the screw members 70 are loosened against the first fixing member 50, the cleat body 30 is allowed to be biasedly positioned to define a bias angle with the bottom plate 1 of the bicycle shoe, such that a suitable angle is produced between the bicycle shoe and the clipless pedal 2 according to the pedaling gesture of the user/rider, thus facilitating the engagement and disengagement of the bicycle shoe and the clipless pedal 2 and enhancing the convenience of usage thereof.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An adjustable bicycle shoe cleat which is fixed to a bottom plate of a bicycle shoe, wherein the bottom plate is provided with two combining holes, the adjustable bicycle shoe cleat comprising:
a cleat body provided with a front engaging end and a rear engaging end in opposite with the front engaging end for being engaged with a clipless pedal, two adjusting bores symmetrically and transversely disposed between the front engaging end and the rear engaging end, each adjusting bore comprising a small arch section and a large arch section, the two small arch sections disposed face to face; and
a fastening assembly provided with two screw members passing through the two adjusting bores for loosenably screwing the cleat body to the two combining holes, such that the cleat body is able to be biasedly positioned against the bottom plate of the bicycle shoe.

2. The adjustable bicycle shoe cleat of claim 1, wherein the two combining holes are strip-shaped and longitudinally disposed in parallel on the bottom plate of the bicycle shoe.

3. The adjustable bicycle shoe cleat of claim 1, wherein the bottom plate is provided with an inner face and an outer face, the fastening assembly further comprising a first fixing member disposed on the inner face and a second fixing member disposed on the outer face, the screw members passing through the second fixing member and the cleat body to be screwedly mounted to the first fixing member.

4. The adjustable bicycle shoe cleat of claim 3, wherein the cleat body is provided with a first surface and a second surface, the first surface facing the combining holes, the two adjusting bores are concavely disposed from the first surface toward the second surface, the second surface is concavely provided with a containing recess, a square measure of the containing recess being larger than a square measure of the second fixing member, the containing recess containing the second fixing member.

5. The adjustable bicycle shoe cleat of claim 3, wherein the first fixing member is provided with two pillars passing through the two combining holes, respectively, each of the pillars having a screw hole for the respective screw member to be screwed thereto.

6. The adjustable bicycle shoe cleat of claim 4, wherein the second fixing member is provided with two counterbores for containing a head part of each of the screw members, so as to prevent the head parts of the screw members from protruding from the second surface of the cleat body.

7. The adjustable bicycle shoe cleat of claim 4, wherein two sides of the containing recess are provided with a blocking edge, respectively.

8. The adjustable bicycle shoe cleat of claim 7, wherein the blocking edges are V-shaped.

9. The adjustable bicycle shoe cleat of claim 1, wherein each of the screw members is provided with a tool driving bore.

10. The adjustable bicycle shoe cleat of claim 1, wherein the inner face of the bottom plate is provided with a recess for containing the two combining holes.
